(19) United States
(12) Patent Application Publication
(10) Pub. No.: US 2003/0163456 A1
(43) Pub. Date: Aug. 28, 2003

(54) Searching digital cable channels based on spoken keywords using a telephone system

(76) Inventors: Shiyan S. Hua, Lisle, IL (US); Ahmed N. Zaki, Lisle, IL (US)

Correspondence Address: John P. Cornely, Fay, Sharpe, Fagan, Minnich & McKee, LLP, Seventh Floor, 1100 Superior Avenue, Cleveland, OH, 44114, US

(21) Appl. No.: 10/087,291

(22) Filed: Feb. 28, 2002

(51) Int. Cl. G06F 7/00

(52) U.S. Cl. 707/3

(57) ABSTRACT

A method of searching TV programming information includes receiving a telephone call from a viewer (10) via a telephone system (22), generating a search query in response to the telephone call, and searching a database (30) in accordance with the search query. The database (30) contains TV programming information. Search results generated from the searching include entries from the database (30) that correspond to the search query. The search results are then sent to a TV receiver box (14) of the viewer (10) via a TV system (16) such that they are displayable upon a TV (12) operatively connected to the receiver box (14).

### BACKGROUND OF THE INVENTION

The present invention relates to the arts of telecommunication and television (TV). It finds particular application in conjunction with digital cable TV, and will be described with particular reference thereto. However, it is to be appreciated that the present invention is also amenable to other like applications, e.g., satellite TV.

TV viewers generally desire to maximize their enjoyment of the viewing experience by tuning in programming that is pleasing to their individual tastes. Therefore, finding particular types of programming becomes and important issue for many TV viewers, especially when there is a limited amount of viewing time available or allotted. Flipping through channels to locate desired programming can be an inefficient, time consuming nuisance. Moreover, by using this method a viewer may settle on one channel without realizing that more desirable programming is currently being aired on another channel, either because that latter channel was not checked or because when that latter channel was “flipped to” a commercial was being aired. This is disadvantageous.

Printed or published TV listings such as found in guides or newspapers still require the TV viewer to read the entire listing to find desired programming. Additionally, printed or published listings cannot readily accommodate last minute or late changes in channel programming. A dedicated channel with scrolling TV listings can also require the TV viewer to read through the entire schedule to find the most desirable programming. Again, this can be undesirably time consuming.

The above problems become all the more exacerbated by the proliferation of channels available on cable and other TV systems. For example, as analog cable systems move on to digital cable systems, the number of channels accommodated can be significantly increased. When presented with a greater number of viewing options, TV viewers will have even greater difficulty locating the most desired programming out of the vast number of choices.

Consequently, many TV viewers find it desirable to have an efficient targeting method and/or system for locating desired programming. Currently, neither analog nor digital cable systems offer any suitable targeted channel searching capabilities.

The present invention contemplates a new and improved system and/or method which overcomes the above-referenced problems and others.

### SUMMARY OF THE INVENTION

In accordance with one aspect of the present invention a method of searching TV programming information is provided. The method includes receiving a telephone call from a viewer via a telephone system, generating a search query in response to the telephone call, and searching a database in accordance with the search query. The database contains TV programming information. Search results generated from the searching include entries from the database that correspond to the search query. The search results are then sent to a TV receiver box of the viewer via a TV system such that they are displayable upon a TV operatively connected to the receiver box.

In accordance with another aspect of the present invention, a SCP connected to a telephone system and a TV system includes query generating means for generating a search query in response to a telephone call received from a viewer via the telephone system, and a database in which TV programming information is maintained. Also included are searching means for searching the database in accordance with the search query received from the query generating means. The searching means generates search results which are sent to a TV receiver box of the viewer via the TV system such that they are displayable upon a TV operatively connected to the TV receiver box.

One advantage of the present invention is that it provides convenient, efficient and targeted searching of TV listings.

Another advantage of the present invention is that optionally real time and/or future TV listing can be searched.

Still further advantages and benefits of the present invention will become apparent to those of ordinary skill in the art upon reading and understanding the following detailed description of the preferred embodiments.

### BRIEF DESCRIPTION OF THE DRAWING(S)

The invention may take form in various components and arrangements of components, and/or in various steps and arrangements of steps. The drawings are only for purposes of illustrating preferred embodiments and are not to be construed as limiting the invention.

FIG. 1 diagrammatic illustration showing a system for conducting keyword searching of TV listings in accordance with aspects of the present invention.

FIG. 2 a flow chart showing an exemplary process for carrying out a targeted TV listings search in accordance with aspects of the present invention.

### DETAILED DESCRIPTION OF THE PREFERRED EMBODIMENT(S)

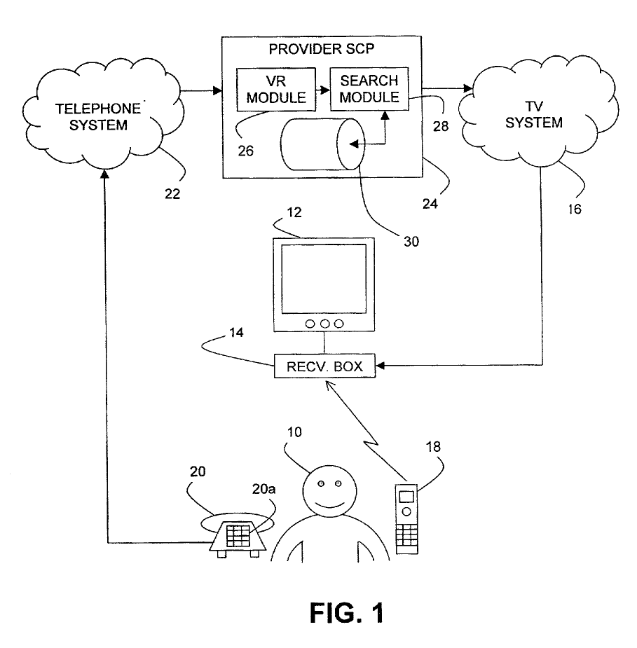

With reference to the FIGURES, in particular FIG. 1, a TV viewer 10 is watching a TV 12 which is operatively connected to a receiver box 14. The receiver box 14 serves as a receiver for TV programming and other content provided by a TV service provider via a traditional TV system 16. Optionally, the TV system 16 is a cable system (digital and/or analog) or a satellite TV system, and the receiver box 14 is a TV cable box or satellite TV receiver, respectively. Preferably, the viewer 10 employs a remote control 18 to select channels and provide other input to the receiver box 14 and/or TV 12. Alternately, the viewer 10 may select channels and provide other input to the receiver box 14 and/or TV 12 via controls incorporated therein.

Only one viewer 10, one TV 12, one receiver box 14, one remote 18 and one telephone 20 are shown for reasons of convenience and simplicity herein. However, it is to be appreciated that multiple such viewers similarly situated are contemplated wherein each is a customer of or otherwise serviced by the TV service provider. Also, optionally, the receiver box 14 is integrated with the TV 12 or the TV 12 is cable ready or otherwise capable of receiving the TV programming and other content provided by the TV service provider directly from the TV system 16. Accordingly, when things are referred to herein as being sent to the TV receiver box 14, this also encompasses sending them directly to the TV 12 when the TV 12 is equipped for direct reception from the TV system 16.

In any event, when desired, the viewer 10 uses a telephone 20 and calls a phone number specified for searching TV listings, e.g., 1 (800) 555-LIST or some other such phone number. The telephone call goes out over a traditional wireline and/or wireless telephone system 22 which routes the call to the TV service provider's service control point (SCP) 24. Upon receipt of the call, the SCP 24 prompts the viewer 10 to speak one or more keywords or other criteria to be used for searching. A voice recognition (VR) module 26 incorporated in the SCP 24 translates or otherwise converts the spoken words into text or another like corresponding data entry which is routed as an input query to a search module 28. The VR module 26 may be any known type of VR module which recognizes audible language or speech and converts it into or otherwise generates corresponding text, data or other machine/computer readable code in response thereto. Similarly, the search module 28 may be any known type of search module or search engine that searches a database in response to an input query and outputs matching or otherwise corresponding entries or results based on the query.

In any event, in response to the input query, the search module 28 performs a search of a database 30 to find entries corresponding to or matching the same. Preferably, the TV service provider maintains their TV listings and/or programming schedules in the database 30. Along with program names or titles and their respective channels, the database 30 also optionally has searchable fields for abstractions of program content, listings of individuals or featured stars appearing, etc. Additionally, the programs may be designated by one or more “types” (e.g., movie, sports, news, sitcom, drama, comedy, etc.) which are also maintained in the database 30 as a searchable field.

Once obtained, the search results are routed via the TV system 16 to the receiver box 14 for display on the TV 12. Preferably, the search results include a list of TV programs and corresponding channels showing the programs. In this manner, the viewer 10 conveniently and efficiently obtains program scheduling and/or TV listing information which is targeted to their particular preferences. Accordingly, the viewer 10 may act upon the information as they see fit, e.g., selecting a desired channel with the remote 18. In the case where no entries are found in the database 30 that suitably correspond to or match the query input into the search module 28, preferably, the search results routed via the TV system 16 to the receiver box 14 indicate the same, e.g., with a message such as “no TV listings or programming match your search criteria” or the like. Preferably, the viewer 10 has the option of scrolling through the resulting list of channels and/or programs, and upon selecting one, detailed information (e.g., the program abstraction) regarding the same is displayed. Optionally, the viewer 10 may use the remote control 18 to scroll through the results list and/or select desired channels for viewing the detailed program information. Further, the viewer 10 may select channels from the resulting list to thereby tune to the selected channel. Optionally, when only one match is found, the corresponding channel is automatically tuned in. The sole matching channel may be automatically tune in immediately or after showing the results for a brief period.

In the case of multiple viewers, it becomes desirable to identify the viewers which are engaged in searching the TV listings so that the search results can be routed to the proper viewers seeking the same. This may be accomplished in a variety of manners. In one embodiment, the viewer 10 is prompted to submit identifying information when their call is connected with the SCP 24. This identifying information may include one or more of the following: their name, their social security number, an assigned account number or ID, a password or personal identification number (PIN), etc. In another embodiment, the SCP 24 utilizes caller ID to obtain the phone number of the telephone 20 from which the call is being placed and cross references that to obtain the identification of the viewer 10 registered to that phone number. Optionally, a combination of both the aforementioned techniques is used with the caller ID technique being a default, and the submission of identifying information technique being a secondary option utilized when the default fails for some reason or a viewer 10 wish to override the default. In any event, once the viewer 10 is identified, the corresponding search results are preferably routed to that viewer's receiver box 14.

Optionally, the database 30 only maintains the current programming schedule and/or TV listings. Alternately, the database 30 maintains the current programming schedule and/or TV listings as well as those for a given time period into the future, e.g., one weeks worth. Accordingly, future TV viewing options can be searched by the viewer 10 thereby allowing the viewer 10 to plan their TV viewing ahead of time. Preferably, to accommodate accurate temporal targeting of searches, one of the search criteria which the viewer 10 is prompted to provide during the connection of their call with the SCP 24 is a time and/or date or range of times and/or dates to be searched.

As shown in FIG. 1, a VR module 26 is employed for converting speech and inputting the desired search query. In additional to or as replacement therefore, other devices and/or techniques may be used to obtain the keywords, search criteria and/or other information from the viewer 10. In one example, a telephone operator, customer support personnel, or other like individual may obtain the keywords, search criteria and other information from the viewer 10 and in accordance therewith enter a corresponding search query into the search module 28. Similarly, an automated telephone call handler (ATCH) may retrieve the keywords, search criteria and other information from the viewer 10. The ATCH may be menu driven and selections entered via the telephone's keypad 20a. Similarly, the telephone's keypad 20a may also be used to enter text and other information by assigning alphanumeric values to designated keystrokes and/or series of keystrokes.

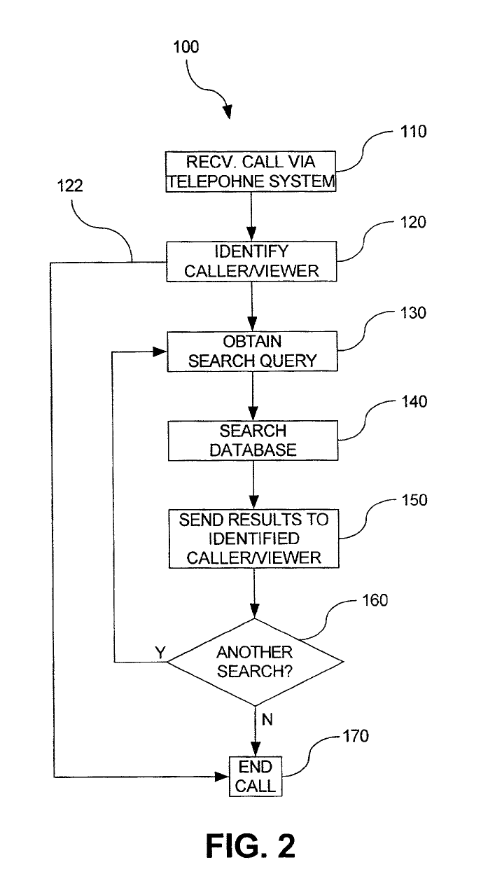

With additional reference to FIG. 2, an exemplary procedure 100 for conducting a targeted search of TV listings is now described. The procedure 100 starts at step 110 with the SCP 24 receiving a call from a viewer 10 via the telephone system 22. At step 120, the caller/viewer 10 is identified. If no identification can be made or the caller/viewer 10 is not a subscriber or otherwise serviced by the TV service provider, the process 100 branches down path 122 and the call is ended. Otherwise, once the caller/viewer 10 is identified, the search query is obtained or otherwise generated at step 130. In accordance with the search query, the database 30 is searched at step 140.

At step 150, the search results are sent to the identified caller/viewer 10 via the TV system 16. Preferably, the receiver box 14 then displays the results on the TV 12 for viewing. That is to say, to view the results, the receiver box 14 is tuned to a designated guide channel where the TV listings and/or programming schedule is normally shown, or the receiver box 14 is otherwise controlled to display the results. Optionally, the displaying of results is carried out automatically when the results are sent, and/or the viewer 10 may selective choose to display the results, e.g., by tuning to the guide channel. When no results have been sent preferably the entire TV listings and/or programming schedule is displayed on the guide channel. The viewer 10 is free to tune in various channels, e.g., those channels listed in the results, to view the same and still display the results by tuning back to the guide channel so long as the results remain active. Optionally, the results remain active for a set duration, for the duration of the call, and/or until another set of search results are sent. Additionally, at or about the time the results are sent, optionally, the SCP 24 will also announce to the caller 10 over the telephone system 22 a summary thereof, e.g., the number of channels matching the search criteria or the like.

At decision step 160, it is determined if another search is desired. This may be carried out by the SCP 24 repeatedly prompting the caller/viewer 10 in timed intervals to enter another search. If another search is desired, the process 100 loops back to step 130 and continues. If however, no other search is desired the process 100 moves on to step 170. It may be decided that no other search is desired when after a number ‘m’ of repeated prompts, no entry is made or received by the SCP 24. Alternately, it may be decided that no other search is desired when the caller/viewer 10 actively indicates the same. Alternately, it may be decided that no other search is desired when the caller/viewer 10 hangs up the phone 20. In any event, at step 170 the call and procedure 100 are ended. Optionally, at the call is ended by the caller/viewer 10 hanging up the phone 20, by inactivity after m repeated prompts, or by the caller/viewer 10 actively indicating their desire to no longer proceed. Again, optionally, at the end of the call any previously sent search results become inactive, and the guide channel goes back to its default state of displaying the entire TV lists and/or programming schedule as instructed by the SCP 24 via the TV system 16.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

having thus described the preferred embodiments, the invention is now claimed to be:

1. A method of searching television programming information comprising:
(a) receiving a telephone call from a viewer via a telephone system;
(b) generating a search query in response to the telephone call;
(c) searching a database in accordance with the search query, said database containing television programming information;
(d) generating search results from the searching, said search results including entries from the database that correspond to the search query; and,
(e) sending the search results to a television receiver box of the viewer via a television system such that said search results are displayable upon a television operatively connected to the receiver box.

2. The method according to claim 1, further comprising:
identifying the viewer from which the telephone call is received via caller ID.

3. The method according to claim 1, wherein the search query is at least partially generated from spoken language from the viewer which is received via the telephone system and input into a voice recognition module.

4. The method according to claim 1, wherein only current television programming information is maintained in the database.

5. The method according to claim 1, wherein current television programming information and a period of future television programming information are maintained in the database.

6. The method according to claim 1, further comprising:
deactivating the search results after the telephone call has terminated such that they are no longer displayable on the television.

7. The method according to claim 1, further comprising:
announcing a summary of the search results to the viewer via the telephone system.

8. The method according to claim 1, wherein the search results include a list of channels showing programs which match the search query.

9. The method according to claim 8, wherein the viewer can selectively scroll through the list of channels.

10. The method according to claim 8, wherein the viewer can select a channel from the list of channels to view information about the program being shown on that channel.

11. A service control point connected to a telephone system and a television system, said service control point comprising:
query generating means for generating a search query in response to a telephone call received from a viewer via the telephone system;
a database in which television programming information is maintained; and,
searching means for searching the database in accordance with the search query received from the query generating means, said searching means generating search results which are sent to a television receiver box of the viewer via the television system such that said search results are displayable upon a television operatively connected to the television receiver box.

12. The service control point of claim 11, wherein the query generating means includes a voice recognition module that receives spoken language from the viewer and converts it into at least a portion of the search query.

13. The service control point of claim 11, wherein only current television programming information is maintained in the database.

14. The service control point of claim 11, wherein current television programming information and a period of future television programming information are maintained in the database.

15. The service control point of claim 11, wherein the television system is selected from a group consisting of a digital cable television system, an analog cable television system, and a satellite television system.

16. The service control point of claim 11, wherein the television programming information includes abstractions of program content.

17. The service control point of claim 11, wherein the database includes a searchable field containing identification of program types.

18. The service control point of claim 11, further comprising:
identification means for identifying the viewer from which a call is received.

19. The service control point of claim 18, wherein the identification means comprises caller ID.

20. The service control point of claim 11, wherein the search results include a list of channels showing programs which match the search query.
